(19) United States
(12) Patent Application Publication
(10) Pub. No.: US 2004/0080851 A1
(43) Pub. Date: Apr. 29, 2004

(54) Process of simultaneous transfer of media data filing information

(76) Inventor: Acacio Neimar de Oliveira, Rio Grande do Sul (BR)

Correspondence Address: Welsh & Katz, Ltd., Jon P. Christensen, 22nd Floor, 120 South Riverside Plaza, Chicago, IL, 60606, US

(21) Appl. No.: 10/690,067

(22) Filed: Oct. 21, 2003

(30) Foreign Application Priority Data
Dec. 29, 2000 (BR) 66125

(51) Int. Cl. G11B 15/12

(52) U.S. Cl. 360/63

(57) ABSTRACT

Pursuant to this invention, the idleness of headsets contained in HDs is eliminated by distributing the signals of information among the headsets for parallel processing. Instead of having a form purely sequential of the data aligned on the sectors, as used in the state of the technique (FIG. 1), these data are distributed among the disk surfaces (FIG. 2), altering the physical form of the disposal of the data, however maintaining the logical form and total compatibility of use for this process.

This invention refers to the process of parallel transfer of signals of information in data filing surface, aiming an improved performance concerning the speed of transfer of information in the devices using said transfers, such as the HD.

It is known that the signals of information at a HD are disposed in sectors on trails, and its content is aligned sequentially, as well as that the headsets are connected by stems to the same control axle, distributed one to each disk surface, responding for the transfer of signals. Upon the request of transfer of information from a specific sector, the control axle is activated, which moves with all headsets, however only tile headset coincident with the face of the disk wherein the trail of the sector is activated, the others remaining deactivated. At the extent in which the set of disks spins, the information moves to the headsets, and upon the coincidence of the sector expected with the headset activated, the information is transferred, observing its order in the sector, i.e., the first signal of information is processed, then the second, the third, and so on, on the same trail, until that it completes the transfer of all signals of information of the sector.

The deficiency in the use of this structural form initially devised, and of the disposal of the signals of information on the disk consists in the inherence of devising only one transfer at each interval of time, restricting the use of the headset to only one, maintaining all others idle during this operation. Therefore, for the processing of 4096 signals, at least 4096 intervals of time will be required.

Considering the idleness and in order to eliminate it, the process of simultaneous transfer object hereof was developed, and it consists in the distribution of the signals of information among the headsets, transferring them to the various disk surfaces, at the same interval of time. A HD with eight headsets processes a group of eight signals in only one interval of time. The number of intervals of time expended is inversely proportional to the number of headsets used for the simultaneous transfer, which means that with this technique, 512 intervals of time will be required to process 4096 signals.

Figures shown:

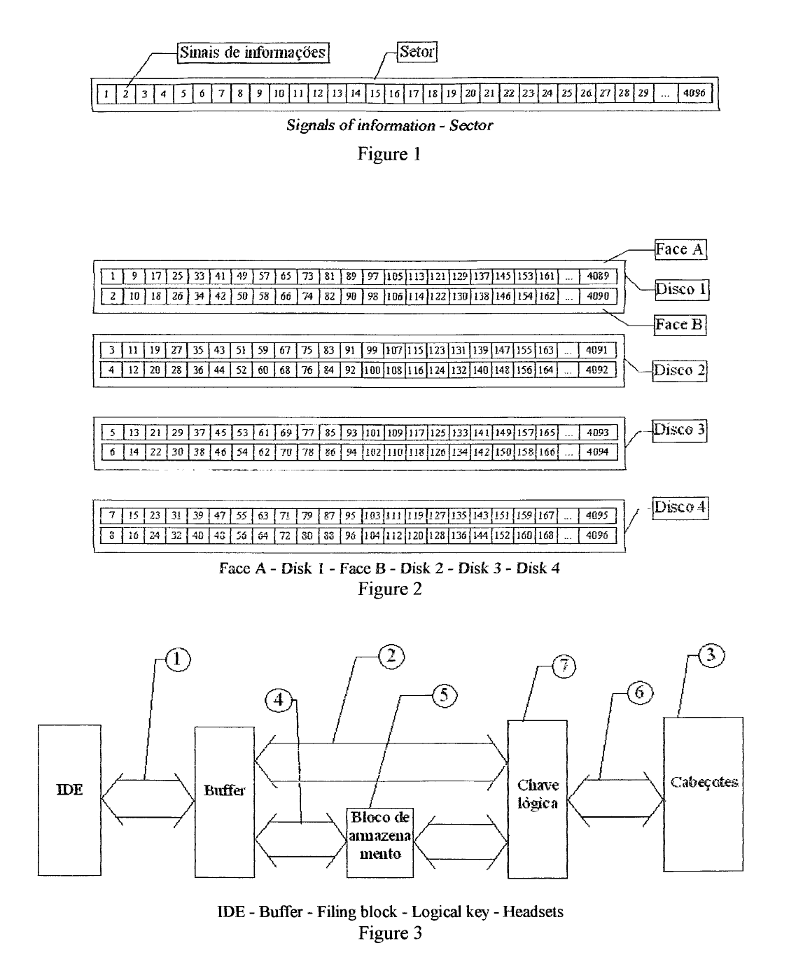

FIG. 1—map of data at a sector of the state of technique.

FIG. 2—map of the physical structure of data in this invention.

FIG. 3—simplified device for data distribution.

The details of this technique consist in devising a new physical structure for data filing, maintaining the logical structure, which allows compatibility with systems using this peripheral. It is known that the IDE works with the transfer, between it and the HD, in groups of sixteen signals of data at each time. When the HD receives a group of signals of information from the IDE (1) it is processed as follows, distributing (7) the first eight signals (2), to the headsets existent (3), leaving the remaining eight signals (4) in standby (5), executes the transfer (6), searches for the following eight standby signals (5) and distributes them (7) to the headsets (3), executes the transfer (6) and repeats this operation for the number of groups of signals that the IDE sends to the HD. It is possible to note that in each transfer, eight signals are processed, then distributed, one signal to each surface, as of FIG. 2. HD with sixteen headsets, which is the number of data channels of IDE, the transfer is carried out completely, without the need standby functions. It is important to stress that for the transfer of the signals of information of the HD to the IDE, the process is the inverse to that explained herein.

1. Process of simultaneous transfer of media data filing information for use in HD, consisting in the continuous use of the headsets, which implies in a specific standard for the physical structure of data distribution to the sectors, with the use of a specific device for this purpose, characterized by the fact of eliminating the idleness of the headsets.

2. Process as of claim 1, characterized by the simultaneous transfer of signals of information in the data filing surfaces of the HD.

3. Process as of claim 1, characterized by the simultaneous use of the headsets in data transfers.

4. Process as of claim 1, characterized by the distribution of the signals of information on a non-sequential manner on the sectors (FIG. 2).

5. Process as of claim 1, characterized by the simultaneous use of headsets at a same surface, for the transfer of signals of information.

6. Process as of claim 1, characterized by the use of the simplified device included in FIG. 3.

7. Process as of claim 4, characterized by the fact of counting on a specific physical structure for the distribution of the signals of information on the sectors.
